(19) United States
(12) Patent Application Publication
(10) Pub. No.: US 2024/0302761 A1
(43) Pub. Date: Sep. 12, 2024

(54) TWO-COMPONENT DEVELOPER AND IMAGE-FORMING APPARATUS

(71) Applicant: Sharp Kabushiki Kaisha, Osaka (JP)

(72) Inventor: TADANORI KANO, Osaka (JP)

(21) Appl. No.: 18/591,259

(22) Filed: Feb. 29, 2024

(30) Foreign Application Priority Data
Mar. 6, 2023 (JP) 2023-033749

(51) Int. Cl. G03G 9/097; G03G 9/08

(52) U.S. Cl. CPC G03G 9/09716; G03G 9/0819; G03G 2215/0607

(57) ABSTRACT

A two-component developer contains a carrier and a toner in which an external additive is attached to a toner particle surface. The external additive contains a fine powder that has an average primary particle diameter of 10 nm to 25 nm and contains aluminum. The two-component developer has an apparent density of 1.7 g/cm³ to 2.0 g/cm³ at a toner concentration in of 4% by mass. A resistance value when a voltage of 1,000 V or 600 V is applied to a magnetic brush having a length of 0.1 cm formed by placing the two-component developer having a toner concentration of 4% by mass at a filling rate of 20% between two electrodes disposed parallel to each other at an interval of 0.1 cm in a magnetic field of 200 mT is 1 GΩ or more or 22 GΩ or less, respectively, per square centimeter of the electrodes.

### BACKGROUND OF THE INVENTION

### Field of the Invention

The present disclosure relates to a two-component developer containing a toner and a carrier, and an image-forming apparatus using the two-component developer.

### Description of the Background Art

A developer used in image formation through an electrophotographic system is classified into a one-component developer containing a toner alone and a two-component developer containing a toner and a carrier. A two-component developer (hereinafter, also simply referred to as developer) is widely used due to the stability in the charge amount held by the toner, which enables high-quality images to be easily obtained. A toner in which an external additive is attached to a toner particle (toner core) surface is widely used.

A two-component developer has a problem that phenomena such as carrier development and development memory occur. Herein, carrier development refers to a phenomenon in which not only a toner but also a carrier are transferred to the surface of a photoreceptor that is an image carrier. Development memory refers to a phenomenon in which a toner remaining on a magnet roller (developing roller) produces a difference in the density of an image between a portion where the toner remains and a portion where no toners remain.

A two-component developer with toner particles having a small particle diameter and fixed at low temperature is difficult to simultaneously prevent the occurrence of carrier development and the occurrence of development memory. The reasons for this are as follows.

When low temperature fixability of toner particles and a reduction in the particle diameter thereof are advanced, a spent toner is likely to be generated on a carrier, and development memory easily occurs. For suppression of the occurrence of this development memory, the magnetization of the carrier is reduced to reduce the attractive force to a sleeve of a magnet roller, but carrier development is likely to occur. FIG. 1 is a schematic view illustrating the occurrence of this carrier development. Low resistance of a developer easily causes negative charge leakage from a sleeve of a magnet roller to a photoreceptor, to induce the carrier development. In order to suppress the negative charge leakage from the sleeve of the magnet roller to a photoreceptor drum, the resistance of the carrier is increased. In this case, it takes time to make the charge distribution of a toner in the developer and a supplied toner uniform, and development memory is likely to occur. FIGS. 2 and 3 are graphs showing a change of the charge distribution of the toner in the developer and the supplied toner. FIG. 2 illustrates the change of the charge distribution when the resistance of the developer is low. FIG. 3 illustrates the change of the charge distribution when the resistance of the developer is high. When the resistance of the developer is low as illustrated in FIG. 2, the charge distribution becomes uniform in a short time, whereas when the resistance of the developer is high as illustrated in FIG. 3, the charge distribution does not become easily uniform, and it takes time to make the charge distribution uniform. A highly charged toner as illustrated by a dashed line part of FIG. 3 clings to a carrier and easily remains on the magnet roller, which causes development memory.

For such behaviors, there has been an issue in which the problem about carrier development and the problem about development memory are not simultaneously solved.

In view of the circumstances, a two-component developer of the present disclosure has been found. An object of the present disclosure is to provide a two-component developer that can suppress the occurrence of carrier development and development memory even when toner particles having a small particle diameter and fixed at low temperature are used, and an image-forming apparatus using the two-component developer.

### SUMMARY OF THE INVENTION

A two-component developer of the present disclosure that is made to solve the problems is a two-component developer containing a toner and a carrier, wherein the toner is a toner in which an external additive is attached to a toner particle surface, the external additive contains a fine powder having an average primary particle diameter of 10 nm or more and 25 nm or less, the fine powder contains aluminum, an apparent density of the two-component developer is 1.7 g/cm³ or more and 2.0 g/cm³ or less at a toner concentration in the two-component developer of 4% by mass, a resistance value when a voltage of 1,000 V is applied to a magnetic brush having a length of 0.1 cm formed by filling a space between two electrodes disposed apart from each other by 0.1 cm and parallel to each other in a magnetic field of 200 mT with the two-component developer having a toner concentration of 4% by mass at a filling rate of 20% is 1 GΩ or more per square centimeter of the electrodes, and a resistance value when a voltage of 600 V is applied to the magnetic brush is 22 GΩ or less per square centimeter of the electrodes.

In the two-component developer, the change amount of the resistance value when a voltage of 600 V is applied to the magnetic brush, per change of 1% by mass when the toner concentration in the two-component developer is changed from 4% by mass to 12% by mass, is preferably 1.0 GΩ or less per square centimeter of the electrodes.

In the two-component developer, the toner preferably has a volume resistivity of 2.0×10¹⁴ Ω·cm or more and 3.7×10¹⁴ Ω·cm or less under compression to a density of 0.9 g/cm³ or more and 1.1 g/cm³ or less.

In the two-component developer, the coverage on the toner particle surface with the fine powder described above is preferably 25% or more and 55% or less.

In the two-component developer, the toner particles preferably have an average primary particle diameter of 4 μm or more and 7 μm or less and an apparent viscosity at 90° C. of 100,000 Pa·s or more and 200,000 Pa·s or less.

In the two-component developer, the ratio of the toner particles having a particle diameter of 0.6×D or less, wherein D is the average primary particle diameter of the toner particles, is preferably 20% or less of the whole particle size distribution of the toner particles.

In the two-component developer, the resistance value when a voltage of 600 V is applied to the magnetic brush having a length of 0.1 cm formed by filling the space between the two electrodes disposed apart from each other by 0.1 cm and parallel to each other in a magnetic field of 200 mT with the two-component developer having a toner concentration of 12% by mass at a filling rate of 20% is preferably 30 GΩ or less per square centimeter of the electrodes.

An image-forming apparatus of the present disclosure that is made to solve the problems is characterized by using the two-component developer.

As conventional techniques, a development method using, under a specific condition, a high-resistant two-component developer in which the resistance value measured by a Bridge method under a condition of an applied voltage of 1,000 V, a distance between electrodes of 2 mm, and a sample amount of 0.2 g is 1.0×10⁸ Ω to 1.0×10¹⁵Ω and a low-resistant two-component developer in which the resistance value measured under the same condition is 1.0×10⁶ Ω to 1.0×10¹³Ω has been known. However, the techniques do not disclose the range of the resistance value of the two-component developer of the present disclosure or the problems to be solved by the two-component developer of the present disclosure.

The two-component developer of the present disclosure and the image-forming apparatus using the two-component developer achieve excellent effects in which the occurrence of carrier development and development memory can be suppressed even when toner particles having a small particle diameter and fixed at low temperature are used.

### BRIEF DESCRIPTION OF THE DRAWINGS

FIG. 1 is a schematic view illustrating the occurrence of carrier development.

FIG. 2 is a graph showing a change of a charge distribution of a toner in a developer and a supplied toner when the resistance of the developer is low.

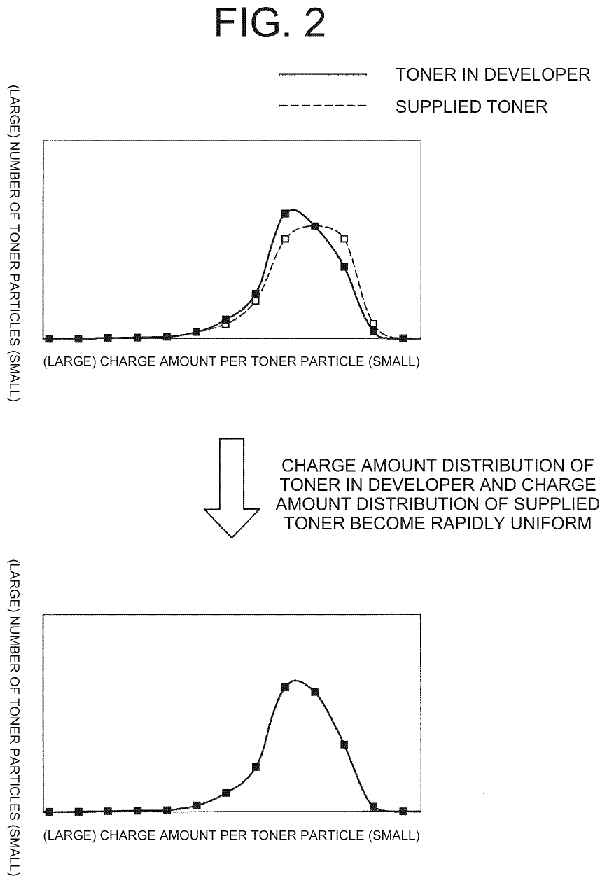

FIG. 3 is a graph showing a change of a charge distribution of a toner in a developer and a supplied toner when the resistance of the developer is high.

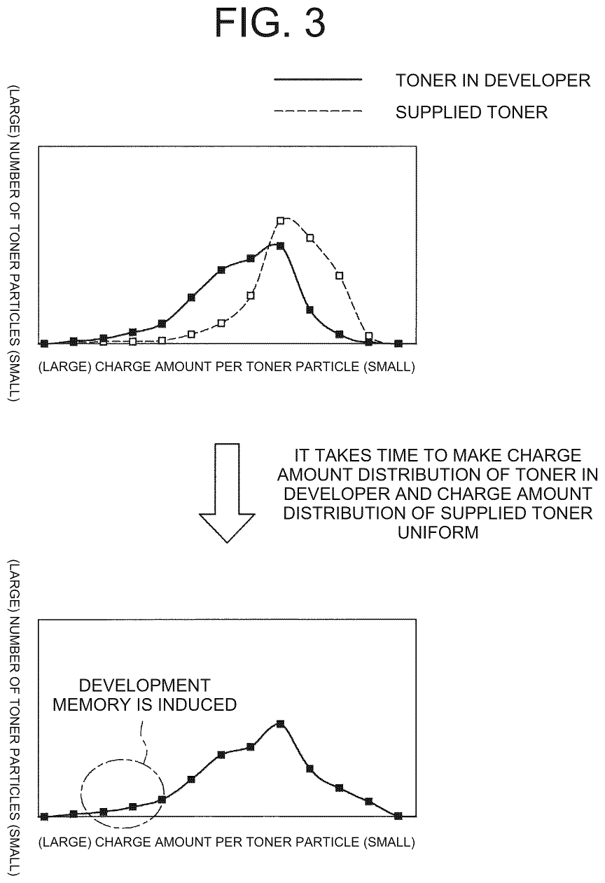

FIG. 4 is a graph showing a measurement result of a resistance value of a magnetic brush of a developer in Comparative Example 1.

FIG. 5 is a graph showing a measurement result of a resistance value of a magnetic brush of a developer in Comparative Example 2.

FIG. 6 is a graph showing a measurement result of a resistance value of a magnetic brush of a developer in Comparative Example 3.

FIG. 7 is a graph showing a measurement result of a resistance value of a magnetic brush of a developer in Example 1.

### DESCRIPTION OF THE PREFERRED EMBODIMENTS

Hereinafter, an embodiment of a two-component developer of the present disclosure will be described. The feature of the whole two-component developer will be first described, and a toner and a carrier contained in the two-component developer will be then described.

### 1. Two-Component Developer

A two-component developer according to the embodiment has an apparent density at a toner concentration of 4% by mass of 1.7 g/cm³ or more and 2.0 g/cm³ or less. The resistance value when a voltage of 1,000 V is applied to a magnetic brush having a length of 0.1 cm formed by filling a space between two electrodes disposed apart from each other by 0.1 cm and parallel to each other in a magnetic field of 200 mT with the two-component developer having a toner concentration of 4% by mass at a filling rate of 20% is 1 GΩ or more per square centimeter of the electrodes, and the resistance value when a voltage of 600 V is applied to the magnetic brush is 22 GΩ or less per square centimeter of the electrodes. The resistance value when a voltage of 1,000 V is applied is more preferably 1.4 G(2 or more, and the resistance value when a voltage of 600 V is applied is more preferably 21 G(2 or less, and still more preferably 20 GΩ or less.

It is empirically considered that in the measurement results of the resistance value of a magnetic brush of the developer formed with a jig used in Examples below, the resistance of the inside of a carrier (the deep region of the carrier) in the developer reflects the resistance value when a voltage of 1,000 V is applied as compared with the resistance value when a voltage of 600 Vis applied. In other words, it is considered that the resistance value when a voltage of 600 V is applied correlates with the resistance on the surface of the carrier and the resistance value when a voltage of 1,000 V is applied correlates with the resistance of the inside of the carrier. Therefore, when the resistance value of the magnetic brush in the two-component developer according to the embodiment is within the aforementioned range, the resistance of the inside and surface of the carrier is controlled. Even when toner particles having a small particle diameter and fixed at low temperature are used, the occurrence of carrier development and development memory can be suppressed.

Next, a mechanism in which the two-component developer according to the embodiment can suppress the occurrence of carrier development and development memory even when the toner particles having a small particle diameter and fixed at low temperature are used will be described.

In order to suppress the occurrence of carrier development, it is desirable that the toner concentration in the developer be reduced and the resistance when a high voltage is applied to the developer be high. In order to suppress the occurrence of development memory, it is desirable that the resistance of the developer be low regardless of the toner concentration in the developer. This is because the charge distribution of the toner supplied to the developer is likely to be made uniform. It is empirically found that when a high electric field is applied to the developer, the resistance of the inside of the carrier expresses. Therefore, the carrier in the two-component developer according to the embodiment is designed such that the resistance of the inside thereof is higher than the resistance of the surface thereof, as described below. In addition, the toner is designed so as to contain a low-resistant charge modifier (a fine powder described below) as an external additive of the toner to reduce the resistance of the toner. According to such a design, the resistance value described above is imparted to the magnetic brush of the developer, and the occurrence of carrier development and development memory can be suppressed even when the toner particles having a small particle diameter and fixed at low temperature are used.

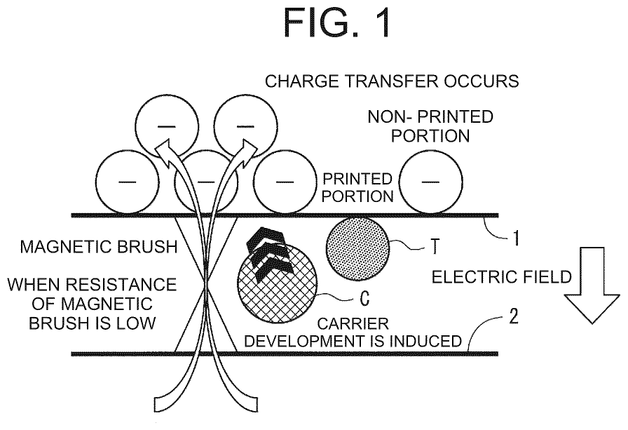

In a low-humidity environment, the charge of the toner is increased, and a developing apparatus applies a high voltage during printing of a high-density image. Depending on a past printing environment history, a high-density image may be printed under such a condition with the toner concentration in the developer being kept low without supplying a toner. When the resistance of the developer is low in this state, electric charge leakage occurs from a sleeve of a magnet roller to a photoreceptor, the carrier is adsorbed on a photoreceptor surface that is excessively and negatively charged, and an image is omitted. This is called carrier development (FIG. 1). It is empirically known that the occurrence of carrier development can be suppressed by increasing the resistance of the developer.

On the other hand, in printing with a developer deteriorated in a high-humidity environment, a phenomenon where the supplied toner is unlikely to be mixed in the developer occurs. An external additive of the toner that is not discharged from a developer tank is buried and excessively charged, and envelops the carrier, and as a result, the supplied toner is inhibited from coming into contact with the carrier. In particular, when toner particles fixed at low temperature and having a small particle diameter of 7 μm or less are used, this is significant. In this case, it takes time to spread and make the charge distribution of the developer uniform. In printing in this state, the developer enveloped by the excessively charged toner covers the magnet roller surface, causing a remaining image. This is called development memory. When the resistances of the toner and the carrier are reduced, excessive charging is suppressed, and the supplied toner is rapidly mixed. Therefore, the occurrence of development memory can be suppressed. However, when the resistances of the toner and the carrier are reduced, carrier development occurs as described above. The reduction in the resistance is not simply executable.

Thus, in the two-component developer according to the embodiment, the carrier is designed such that the resistance of the inside is high and the resistance of the surface is low, and the toner is designed so as to contain a charge modifier having a small particle diameter and low resistance as an external additive. This is considered to make it possible to suppress the occurrence of carrier development and development memory.

In the two-component developer according to the embodiment, the change amount of the resistance value when a voltage of 600 V is applied to the magnetic brush, per change of 1% by mass when the toner concentration is changed from 4% by mass to 12% by mass, is preferably 1 GΩ or less, more preferably 0.7 GΩ or less, and still more preferably 0.5 G(2 or less, per square centimeter of the electrodes. When the change amount of the resistance value is more than the upper limit, a charge difference between the toner in the developer tank and the supplied toner is unlikely to be uniform, and development memory may easily occur. In the measurement of the change amount of the resistance value, the filling rate of the two-component developer relative to the volume of the space between the two electrodes is fixed to 20% for measurement although the apparent density of the two-component developer varies with a change in the toner concentration.

In the two-component developer according to the embodiment, the resistance value when a voltage of 600 V is applied to the magnetic brush having a length of 0.1 cm formed by filling the space between the two electrodes disposed apart from each other by 0.1 cm and parallel to each other in a magnetic field of 200 mT with the two-component developer having a toner concentration of 12% by mass at a filling rate of 20% is preferably 30 G(2 or less, more preferably 27 GΩ or less, and still more preferably 24 GΩ or less, per square centimeter of the electrodes. When the resistance at a high toner concentration of 12% by mass is more than the upper limit, development memory may easily occur.

### 2. Toner

The toner contained in the two-component developer according to the embodiment is a toner in which an external additive is attached to a toner particle (toner core) surface. The toner particles according to the embodiment include an internal additive such as a colorant, a release agent, and a charge control agent, and a binder resin, and the internal additive is dispersed in the binder resin. The toner particles may further contain an optional component, as necessary, as long as the effects of the present disclosure are not impaired. The average primary particle diameter of the toner particles can be appropriately selected according to purposes, and is, for example, 4 μm or more and 10 μm or less. It is preferably 4 μm or more and 7 μm or less since the two-component developer of the present disclosure is suitable to solve the problems when the toner particles having a small particle diameter are used, as described above.

The volume resistivity of the toner according to the embodiment under compression to a density of 0.9 g/cm³ or more and 1.1 g/cm³ or less is preferably 2.0×10¹⁴ Ω·cm or more and 3.7×10¹⁴ Ω· cm or less, and more preferably 3.0×10¹⁴ Ω·cm or more and 3.7×10¹⁴ Ω·cm or less. When the volume resistivity is within the aforementioned range, the toner has a configuration that can more suppress the occurrence of carrier development and development memory. When the coverage on the toner particle surface with a fine powder contained as the external additive, and the apparent viscosity and particle size distribution of the toner particles satisfy conditions described below, the volume resistivity of the toner according to the embodiment is likely to be within the aforementioned range.

The apparent viscosity at 90° C. of the toner particles according to the embodiment is preferably 100,000 Pa·s or more and 200,000 Pa·s or less, and more preferably 150,000 Pa·s or more and 190,000 Pa·s or less. When the apparent viscosity is within the aforementioned range, the fine powder contained as the external additive in the toner according to the embodiment can be inhibited from being buried in the toner particles, and the resistance of the toner according to the embodiment is likely to be maintained. When the apparent viscosity is less than the lower limit, the fine powder is buried in the toner particles, the surface resistance of the toner is increased with an increase in the number of printing sheets, and development memory may easily occur.

The average primary particle diameter of the toner particles according to the embodiment is represented by D. The ratio of the toner particles having a particle diameter of 0.6×D or less is preferably 20% or less, and more preferably 17% or less, of the whole particle size distribution of the toner particles. When the ratio of the toner particles having a particle diameter of 0.6×D or less is more than the upper limit, the specific surface area of the toner particles is increased, the coverage on the toner particle surface with the fine powder as the external additive is reduced, and the surface resistance of the toner tends to be increased. Furthermore, the adhesive force of the toner to the sleeve of the magnet roller is increased, and development memory may easily occur. When the ratio of the toner particles having a particle diameter of 0.6×D or less is within the aforementioned range, the adhesive force of the toner to the sleeve of the magnet roller is reduced, and the occurrence of development memory can be suppressed.

Hereinafter, each material constituting the toner according to the embodiment will be described.

### Binder Resin

As the binder resin contained in the toner particles according to the embodiment, an amorphous polyester resin can be suitably used. As long as the effects of the present disclosure are not impaired, the binder resin may include a component other than the amorphous polyester resin.

Here, a polyester resin can be classified into an amorphous polyester resin and a crystalline polyester resin according to a crystallinity index. In the present disclosure, a resin having a crystallinity index falling within a range of 0.6 or more and 1.5 or less is assumed to be the crystalline resin whereas a resin having a crystallinity index of less than 0.6 or more than 1.5 is assumed to be the amorphous resin. A resin having a crystallinity index of more than 1.5 is amorphous, and a resin having a crystallinity index of less than 0.6 has low crystallinity and includes a large amount of amorphous parts.

The crystallinity index is a physical property to be an index of degree of crystallization of a resin, and is defined by a ratio of softening temperature to endothermic maximum peak temperature (softening temperature/endothermic maximum peak temperature). Here, endothermic maximum peak temperature designates a temperature of a peak located closest to the highest temperature among endothermic peaks observed. The crystalline polyester resin is set to have a maximum peak temperature defined as a melting point, and the amorphous polyester resin is set to have a peak closest to the highest temperature defined as a glass-transition point.

The degree of crystallization of the resin can be controlled by adjusting a type and ratio of a material monomer, and a production condition (e.g., reaction temperature, reaction time, cooling rate), and the like.

The amorphous polyester resin used in the toner according to the embodiment is obtained, for example, by performing polycondensation on a dicarboxylic acid monomer that includes terephthalic acid or isophthalic acid as the main component and a diol monomer that includes ethylene glycol as the main component.

The dicarboxylic acid monomer used in the synthesis of the amorphous polyester resin includes terephthalic acid or isophthalic acid as the main component. Here, the molar content of terephthalic acid or isophthalic acid included in the dicarboxylic acid monomer is preferably 70% or more and 100% or less, and more preferably 80% or more and 100% or less.

The dicarboxylic acid monomer described above may include an aromatic dicarboxylic acid or an aliphatic dicarboxylic acid other than terephthalic acid and isophthalic acid. Examples of the aromatic dicarboxylic acid other than terephthalic acid and isophthalic acid include fumaric acid, and examples of the aliphatic dicarboxylic acid include adipic acid, sebacic acid, and succinic acid. The dicarboxylic acid monomer may also include an ester forming derivative of terephthalic acid or isophthalic acid, an ester forming derivative of the aromatic dicarboxylic acid other than terephthalic acid and isophthalic acid, and an ester forming derivative of the aliphatic dicarboxylic acid. In the present disclosure, the ester forming derivative includes an acid anhydride of a carboxylic acid, an alkyl ester, and the like. Such dicarboxylic acid monomers may be used alone or in combination of two or more types.

In the synthesis of the amorphous polyester resin, together with the dicarboxylic acid monomer, a polycarboxylic acid monomer having a valency of three or more may be used. As the polycarboxylic acid monomer having a valency of three or more, a polycarboxylic acid having a valency of three or more such as trimellitic acid or pyromellitic acid, or an ester forming derivative thereof can be used. Such polycarboxylic acid monomers having a valency of three or more may be used alone or in combination of two or more types.

The diol monomer used in the synthesis of the amorphous polyester resin includes ethylene glycol as the main component. Here, the molar content of ethylene glycol included in the diol monomer is preferably 70% or more and 100% or less, and more preferably 80% or more and 100% or less.

The diol monomer described above may include 1,3-propylene glycol, 1,4-butanediol, or the like. Such diol monomers may be used alone or in combination of two or more types.

The amorphous polyester resin used in the toner according to the embodiment can be manufactured in the same manner as a normal polyester manufacturing method. For example, a dicarboxylic acid monomer, a diol monomer, and in some cases, a polycarboxylic acid monomer having a valency of three or more are used, a polycondensation reaction is performed in an atmosphere of nitrogen gas at a temperature of 190° C. to 240° C., and thus it is possible to synthesize the amorphous polyester resin.

In the polycondensation reaction described above, the reaction ratio of the diol monomer and a carboxylic acid monomer (including the dicarboxylic acid monomer and in some cases, the polycarboxylic acid monomer having a valency of three or more) is preferably 1.3:1 to 1:1.2 as the equivalent ratio [OH]: [COOH] of a hydroxy group to a carboxyl group. In the polycondensation reaction described above, the molar content of the dicarboxylic acid monomer included in the carboxylic acid monomer is preferably 80 to 100%. Furthermore, in the polycondensation reaction described above, as necessary, an esterification catalyst such as dibutyltin oxide or titanium alkoxide (for example, tetrabutoxytitanate) may be used.

The content of the amorphous polyester resin in the toner particles according to the embodiment is preferably 40% by mass or more and 95% by mass or less, and more preferably 50% by mass or more and 80% by mass or less.

### Crystalline Polyester Resin

In the toner according to the embodiment, the toner particles may contain a crystalline polyester resin. The crystalline polyester resin in the toner particles is dispersed in the amorphous polyester resin. The crystalline polyester resin is a crystalline polyester resin that is formed with linear saturated aliphatic polyester units obtained by performing polycondensation on a dicarboxylic acid monomer that includes an aliphatic dicarboxylic acid having 9 to 22 carbon atoms as the main component and a diol monomer that includes an aliphatic diol having 2 to 10 carbon atoms as the main component. The crystalline polyester resin is formed with the linear saturated aliphatic polyester units, and thus this crystalline polyester resin and the amorphous polyester resin are unlikely to be compatible with each other.

The dicarboxylic acid monomer used in the synthesis of the crystalline polyester resin includes the aliphatic dicarboxylic acid having 9 to 22 carbon atoms as the main component. Here, the molar content of the aliphatic dicarboxylic acid having 9 to 22 carbon atoms included in the dicarboxylic acid monomer is preferably 80% or more and 100% or less.

Examples of the aliphatic dicarboxylic acid having 9 to 22 carbon atoms described above include azelaic acid, sebacic acid, 1,10-decanedicarboxylic acid, and 1,18-octadecanedicarboxylic acid. The dicarboxylic acid monomer may include ester forming derivatives of these aliphatic dicarboxylic acids. Such dicarboxylic acid monomers may be used alone or in combination of two or more types.

In the synthesis of the crystalline polyester resin, together with the dicarboxylic acid monomer described above, a polycarboxylic acid monomer having a valency of three or more may be used. As the polycarboxylic acid monomer having a valency of three or more, a polycarboxylic acid having a valency of three or more such as trimellitic acid or pyromellitic acid, or an ester forming derivative thereof can be used. Such polycarboxylic acid monomers having a valency of three or more may be used alone or in combination of two or more types.

The diol monomer used in the synthesis of the crystalline polyester resin includes the aliphatic diol having 2 to 10 carbon atoms as the main component. Here, the molar content of the aliphatic diol having 2 to 10 carbon atoms included in the diol monomer is preferably 80% or more and 100% or less.

Examples of the aliphatic diol having 2 to 10 carbon atoms include ethylene glycol, 1,4-butanediol, and 1,6-hexanediol. Such diol monomers may be used alone or in combination of two or more types.

In the synthesis of the crystalline polyester resin, together with the diol monomer described above, a polyol monomer having a valency of three or more may be used. As the polyol monomer having a valency of three or more, glycerin, trimethylolpropane or the like can be used. Such polyol monomers having a valency of three or more may be used alone or in combination of two or more types.

The crystalline polyester resin used in the toner according to the embodiment can be manufactured in the same manner as a normal polyester manufacturing method. For example, a dicarboxylic acid monomer, a diol monomer, in some cases, a polycarboxylic acid monomer having a valency of three or more and a polyol monomer having a valency of three or more are used, a polycondensation reaction is performed in an atmosphere of nitrogen gas at a temperature of 190° C. to 240° C., and thus it is possible to synthesize the crystalline polyester resin.

In the polycondensation reaction described above, the equivalent ratio (OH group/COOH group) of the hydroxy group of the polyol monomer (including the diol monomer and in some cases, the polyol monomer having a valency of three or more) to the carboxyl group of the carboxylic acid monomer (including the dicarboxylic acid monomer and in some cases, the polycarboxylic acid monomer having a valency of three or more) is preferably 0.83 to 1.3 in terms of the storage property and the like. In the polycondensation reaction described above, the molar content of the dicarboxylic acid monomer included in the carboxylic acid monomer is preferably 90 to 100%. As the molar content of the dicarboxylic acid monomer described above is lower, the ratio and rate of crystallization are lowered, with the result that toner agglomeration resistance is insufficient. Furthermore, in the polycondensation reaction described above, the molar content of the diol monomer included in the polyol monomer is preferably 80 to 100%. Furthermore, in the polycondensation reaction described above, as necessary, an esterification catalyst such as dibutyltin oxide or titanium alkoxide (for example, tetrabutoxytitanate) may be used.

The content of the crystalline polyester resin in the toner particles according to the embodiment is preferably 5% by mass or more and 50% by mass or less, and more preferably 10% by mass or more and 30% by mass or less.

### Release Agent

The toner particles according to the embodiment include a wax as a release agent. The wax is preferably an ester wax. When an endothermic peak temperature derived from the ester wax in a temperature rise, which is measured with a differential scanning calorimeter, is represented by T1 and an exothermic peak temperature derived from the ester wax in cooling, which is measured with a differential scanning calorimeter, is represented by T2, T1-T2 is preferably 15° C. or more and 30° C. or less, and more preferably 17° C. or more and 23° C. or less. The ester wax in which T1-T2 satisfies the condition has a high internal lubrication effect (an effect that enhances compatibility of materials during melt-kneading).

When the wax is blended into the toner particles, local charge up can be suppressed even in a low-humidity environment, and burying the external additive can be suppressed throughout life-time. Specifically, a toner that is excellent in environmental charge stability and charge stability throughout life-time can be obtained.

Examples of the ester wax include product name: WE-14, WE-15, and WEP-5 manufactured by NOF CORPORATION.

The content of the wax in the toner particles according to the embodiment is preferably 0.5% by mass or more and 8% by mass or less, and more preferably 2% by mass or more and 7% by mass or less.

### Colorant

The toner particles according to the embodiment may contain the colorant. The colorant is not particularly limited, and an organic dye, an organic pigment, an inorganic dye, an inorganic pigment and the like that are used in an electrophotographic field can be used.

Examples of a black colorant include carbon black, copper oxide, manganese dioxide, aniline black, activated carbon, non-magnetic ferrite, magnetic ferrite, and magnetite.

Examples of a yellow colorant include C. I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, and C.I. Pigment Yellow 185.

Examples of a magenta colorant include C. I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of a cyan colorant include C. I. Pigment Blue 15, C.I. Pigment Blue 15:2, C.I. Pigment Blue 15:3, C.I. Pigment Blue 16, and C.I. Pigment Blue 60.

Although in the toner according to the embodiment, the content of the colorant is not particularly limited, the content is preferably 4% by mass or more and 10% by mass or less in the toner particles. The colorant may be used alone or in combination of two or more types. The colorant may be formed into masterbatches to be used so that the colorant is uniformly dispersed in the binding resin.

### Charge Control Agent

The toner particles according to the embodiment may contain the charge control agent. The charge control agent is added to provide chargeability suitable for the toner. The charge control agent is not particularly limited, and charge control agents for positive charge control and negative charge control that are used in the electrophotographic field can be used.

Examples of the charge control agent for positive charge control include a quaternary ammonium salt, a pyrimidine compound, a triphenylmethane derivative, a guanidine salt, and an amidine salt.

Examples of the charge control agent for negative charge control include a metal-containing azo compound, an azo complex dye, salicylic acid, metal complexes and metal salts (metals are chromium, zinc, zirconium and the like) of their derivatives, an organic bentonite compound, and a boron compound.

The content of the charge control agent in the toner particles according to the embodiment is not particularly limited, but is preferably 0.5% by mass or more and 5% by mass or less. The charge control agent may be used alone or in combination of two or more types.

### External Additive

The toner according to the embodiment contains a fine powder having an average primary particle diameter of 10 nm or more and 25 nm or less as an external additive, and the fine powder contains aluminum.

The fine powder contained as the external additive in the toner according to the embodiment has lower resistance than the binder resin constituting the toner particles and functions as the charge modifier. The charge control agent is preferably designed so as to have a function of reducing the surface resistance of the toner to suppress the occurrence of development memory. The particle diameter and addition amount of the fine powder are adjusted to reduce the surface resistance of the toner. However, when the addition amount is not within a proper range, the environmental charge performance is reduced, and the resistance of the developer in a high electric field is excessively reduced, to induce carrier development. As a result of intensive studies by the present inventor, the charge modifier contained as the external additive in the toner of the two-component developer according to the present disclosure is preferably a fine powder containing aluminum such as aluminum oxide, a composition of aluminum hydroxide and silica, or aluminum stearate.

When the fine powder is aluminum oxide, examples of crystalline structure thereof include α-alumina, β-alumina, γ-alumina, and θ-alumina. From the viewpoint of enhancing environment charge performance, α-alumina is preferred.

For hydrophobization, the fine powder is preferably a fine powder in which a surface of a base body containing aluminum, such as aluminum oxide, is treated with a surface treatment agent such as octyl triethoxysilane, decyl trimethoxysilane, or dimethyl polysiloxane.

From the viewpoint of the surface resistance of the toner, the average primary particle diameter of the fine powder is 10 nm or more and 25 nm or less, and preferably 12 nm or more and 20 nm or less.

The coverage on the toner particle surface with the fine powder is preferably 25% or more and 55% or less, and more preferably 30% or more and 50% or less. In this case, the surface resistance of the toner is reduced, and the occurrence of development memory and carrier development can be suppressed. When the coverage is more than the upper limit, the surface resistance of the toner is too low, carrier development may occur, and fog may be generated in a high-humidity environment. When the coverage is less than the lower limit, the surface resistance of the toner is too high, development memory may occur, and white sports may be generated in a low-humidity environment.

The volume resistivity of the fine powder is preferably 2.0×10¹¹ Ω·cm or more and 2.0×10¹⁴ Ω·cm or less, and more preferably 3.0×10¹¹ Ω·cm or more and 8.0×10¹¹ Ω·cm or less. When the volume resistivity of the fine powder is within the aforementioned range, the resistance value of the magnetic brush of the developer is easily adjusted within a range defined in the present disclosure. However, the volume resistivity of the fine powder is not necessarily limited to the aforementioned range.

### 3. Carrier

The carrier is stirred and mixed with the toner in a developer tank to provide the toner with a desired charge. The carrier also functions as an electrode between a developing apparatus and a photoconductor, and serves to carry the charged toner to an electrostatic latent image on the photoconductor and to form a toner image. The carrier is held on a magnet roller (developing roller) of the developing apparatus by magnetic force, affects developing, then returns to the developer tank again, and is stirred and mixed with a new toner again to be repeatedly used until its life-span expired.

The carrier includes a carrier core material and a resin coating layer coating a surface of the carrier core material. The resin coating layer formed from a resin for carrier may be treated with a coupling agent.

The carrier according to the embodiment is more preferably designed such the surface resistance of the carrier is reduced to suppress the occurrence of development memory, and in addition, is preferably designed such that the resistance of the carrier is not reduced under application of a high electric field to suppress the occurrence of carrier development. In order to achieve such designs, the carrier according to the embodiment preferably has such a configuration that the resistance of the inside of the carrier is higher than the resistance of the carrier surface. A carrier B in Examples below has such a configuration that a carrier core material is coated with a two-layer resin coating layer that includes a lower layer and an upper layer in order from a side of the carrier core material, the lower layer does not contain conductive fine particles, the upper layer contains conductive fine particles, the resistance of the inside is high, and the resistance of the surface is low. In addition to such a configuration, the carrier appropriate for the two-component developer according to the present disclosure can be produced by increasing the resistance of the carrier core material and coating the carrier core material with a coating resin liquid to which a large amount of conductive fine particles is added.

In the carrier according to the embodiment, the apparent density of the carrier coated with the resin coating layer is more preferably 2.0 g/cm³ or more and 2.5 g/cm³ or less, and the mobility of the carrier is preferably 25 g/second or more and 35 g/second or less. When the apparent density or mobility of the carrier is within the aforementioned range, the resistance value of the magnetic brush of the developer is easily adjusted within a range defined in the present disclosure. However, the apparent density or mobility of the carrier is not necessarily limited to the aforementioned range.

### Carrier Core Material

As the carrier core material, those commonly used in the technical field can be used. Examples thereof include magnetic metals such as iron, copper, nickel, and cobalt, and magnetic metal oxides such as ferrite and magnetite. In the case of the carrier core material, a carrier suitable for a developer used in the magnetic brush development method can be obtained.

Of these, the carrier core material is preferably a particle containing a ferrite component. Since ferrite has high saturation magnetization, a coated carrier having a low density can be obtained. Therefore, in use of the coated carrier for the developer, the coated carrier is unlikely to be attached to a photoreceptor, a soft magnetic brush is formed, and an image having high dot reproduction can be obtained.

Examples of ferrite include zinc-based ferrite, nickel-based ferrite, copper-based ferrite, barium ferrite, strontium ferrite, nickel-zinc-based ferrite, magnesium-magnesium-based ferrite, copper-magnesium-based ferrite, manganese-zinc-based ferrite, manganese-copper-zinc-based ferrite, and magnesium-magnesium-strontium-based ferrite.

Ferrite can be produced by a known method. For example, ferrite raw materials such as Fe₂O₃ and Mg(OH)₂ are mixed, and this mixed powder is heated and calcined in a heating furnace. The resulting calcined product is cooled, milled with a vibration mill into particles of about 1 μm, and to the milled powder, a dispersant and water are added to produce a slurry. This slurry is wet-milled with a wet ball mill, and the resulting suspension is granulated and dried with a spray drier, to obtain ferrite particles.

The average primary particle diameter of the carrier core material is preferably 25 μm or more and 50 μm or less, and more preferably 30 μm or more and 50 μm or less. When the average primary particle diameter of the carrier core material is within the aforementioned range, the toner can be stably transported to an electrostatic latent image formed on the photoreceptor, and a highly fine image can be formed over an extended period. When the average primary particle diameter of the carrier core material is less than the lower limit, control of adhesion of the carrier may be difficult. In contrast, when the average primary particle diameter of the carrier core material is more than the upper limit, a highly fine image may not be formed.

### Resin for Carrier

A resin forming the resin coating layer is not particularly limited, and a resin commonly used in the technical field can be used. Examples of the resin include a polyester resin, an acrylic resin, an acrylic modified resin, a silicone resin, and a fluorine resin. Such resins may be used alone or in combination of two or more types.

Examples of the acrylic resin include a polyacrylate, polymethyl methacrylate, polyethyl methacrylate, poly-n-butyl methacrylate, polyglycidyl methacrylate, a fluorine-containing polyacrylate, a styrene-methacrylate copolymer, a styrene-butyl methacrylate copolymer, and a styrene-ethyl acrylate copolymer.

Examples of commercially available acrylic resin include product name: DIANAL SE-5437 manufactured by MITSUBISHI RAYON CO., LTD., product name: S-LEC PSE-0020 manufactured by SEKISUI CHEMICAL CO., LTD., product name: HIMER ST95 manufactured by SANYOKASEI CO., LTD., and product name: FM601 manufactured by Mitsui Chemicals, Inc.

The silicone resin can suppress the generation of a spent toner and improve the adherence between the carrier core material and the resin coating layer. In particular, a cross-linked silicone resin is preferred.

Examples of a commercially available cross-linked silicone resin include product name: SR2400, SR2410, SR2411, SR2510, SR2405, 840RESIN, and 804RESIN manufactured by Dow corning toray CO., Ltd., and product name: KR350, KR271, KR272, KR274, KR216, KR280, KR282, KR261, KR260, KR255, KR266, KR251, KR155, KR152, KR214, KR220, X-4040-171, KR201, KR5202, and KR3093 manufactured by Shin-Etsu Chemical Co., Ltd.

The resin forming the resin coating layer is preferably the silicone resin, and particularly preferably the cross-linked silicone resin. The resin may contain another resin as long as a preferable property is not impaired. Examples of the other resin include an epoxy resin, a urethane resin, a phenol resin, an acrylic resin, a styrene resin, a polyamide, a polyester, an acetal resin, a polycarbonate, a vinyl chloride resin, a vinyl acetate resin, a cellulose resin, a polyolefin, a fluororesin, copolymer resins thereof, and blended resins thereof. Of these, an acrylic resin is preferred in terms of charge ability. For example, in order to enhance the humidity resistance, demouldability, and the like of the resin coating layer formed from the silicone resin (particularly the cross-linked silicone resin), a difunctional silicone oil may be contained.

### Conductive Fine Particles

The resin coating layer preferably contains conductive fine particles. Thus, the electric charge-imparting capability of the carrier to the toner can be stably enhanced. Therefore, charge up of the carrier can be suppressed.

The conductive fine particles are not particularly limited, and conductive fine particles commonly used in the technical field can be used. Examples thereof include conductive carbon black, and oxides such as conductive titanium oxide-tin oxide.

A small addition amount of carbon black can express conductivity, and is suitable for a black toner. However, carbon black may be detached from the resin coating layer. Therefore, antimony-doped conductive titanium oxide is suitable for a color toner.

The blending amount of the conductive fine particles is not particularly limited, but is preferably 1 part by mass or more and 25 parts by mass or less, and more preferably 1 part by mass or more and 20 parts by mass or less, relative to 100 parts by mass of the resin forming the resin coating layer. When the blending amount of the conductive fine particles is less than the lower limit, an effect due to blending of the conductive fine particles may not be obtained. In contrast, when the blending amount of the conductive fine particles is more than the upper limit, the resin coating layer may not be uniformly formed.

### Coupling Agent

The resin coating layer may further contain a coupling agent such as a silane coupling agent for adjustment of a toner charge amount. Of the silane coupling agent, a silane coupling agent having an electron-donating functional group is preferred. Examples thereof include an amino group-containing silane coupling agent represented by the following formula:

(Y)ₙSi(R)ₘ

wherein R is the same or different, and is a C₁ to C₄ alkyl group, a C₁ to C₄ alkoxy group, or a chlorine atom, Y is the same or different, and is a C₁ to C₁₀ saturated hydrocarbon and/or aromatic hydrocarbon group having an amino group, m and n are each an integer of 1 to 3, and m+n is 4.

Examples of the alkyl group represented by R in the formula include linear or branch alkyl groups having 1 to 4 carbon atoms, such as a methyl group, an ethyl group, a propyl group, an isopropyl group, a butyl group, an isobutyl group, and a tert-butyl group. Of these, a methyl group is preferred.

Examples of the alkoxy group represented by R in the formula include linear or branch alkoxy groups having 1 to 4 carbon atoms, such as a methoxy group, an ethoxy group, a propoxy group, an isopropoxy group, a butoxy group, an isobutoxy group, and a tert-butoxy group. Of these, a methoxy group and an ethoxy group are preferred.

Examples of the saturated hydrocarbon/aromatic hydrocarbon group having an amino group represented by Y in the formula include-(CH₂)ₐ—X (wherein X is an amino group, an aminocarbonylamino group, an aminoalkylamino group, a phenylamino group, or a dialkylamino group, and a is an integer of 1 to 4), and -Ph-X (wherein X has the same meanings as described above, and -Ph- is a phenylene group).

Specific examples of the amino group-containing silane coupling agent include as follows.
H₂N(H₂C)₃Si(OCH₃)₃
H₂N(H₂C)₃Si(OC₂H₅)₃
H₂N(H₃C)₃Si(CH₃)(OCH₃)₂
H₂N(H₂C)₂HN(H₂C)₃Si(CH₃)(OCH₃)₂
H₂NOCHN(H₂C)₃Si(OC₂H₅)₃
H₂N(H₂C)₂HN(H₂C)₃Si(OCH₃)₃
H₂N-Ph-Si(OCH₃)₃ (wherein -Ph- is a p-phenylene group)
Ph-HN(H₂C)₃Si(OCH₃)₃ (wherein Ph—is a phenyl group)
(H₉C₄)₃N(H₂C)₃Si(OCH₃)₃

The coupling agent may be used alone or in combination of two or more types. The blending amount of the coupling agent is not particularly limited, but is preferably 1 part by mass or more and 15 parts by mass or less, and more preferably 5 parts by mass or more and 15 parts by mass or less, relative to 100 parts by mass of the resin for carrier. When the blending amount of the coupling agent is within the aforementioned range, the toner can be sufficiently charged, and the mechanical strength of the resin coating layer cannot be significantly reduced.

### EXAMPLES

Hereinafter, the toner of the present disclosure will be specifically described on the basis of Examples and Comparative Examples. Various measurement methods and evaluation methods will be first described. Hereinafter, a toner in which an external additive is attached to a toner particle surface is also referred to as a “toner with an external additive”.

### Measurement Method

Method for Measuring Apparent Density of Developer 50 g of developer was placed in a 50-mL polyethylene bottle (iboi manufactured by AS ONE Corporation), then stirred with the circumference of the bottle being rotated by a ball mill at a rate of 200 rpm for 120 seconds, and take out of the bottle. The apparent density of the taken developer was measured by a measurement method using a jig in accordance with JIS Z 2504 (Metallic powders-Determination of apparent density).

Method for Measuring Volume Resistivity of Toner

1 g of toner was placed in a powder molding dice and pressed using a bench pressing machine at 20 kN for 30 seconds, to produce a molded sample. The volume resistivity of the molded sample was measured in accordance with JIS K 6911 (Testing methods for thermosetting plastics).

### Method for Measuring Resistance Value of Magnetic Brush of Developer

A jig in which two 1-mm stainless plates are disposed in parallel at an interval of 1 mm as electrodes on a base of a glass epoxy resin was used. A developer for measurement of resistance value was weighed such that the filling rate was 20% of the volume of the space between the electrodes, and then placed between the electrodes. Two anisotropic ferrite magnets of 100 milliteslas (mT) were opposed to each other as the north pole and the south pole so as to hold the whole stainless plates as the electrodes between the two anisotropic ferrite magnets, and a magnetic brush of the developer was formed between the electrodes. The electrodes were wired and connected to an electrometer (model: R8340, manufactured by ADVANTEST CORPORATION), and a voltage of 1,000 V or 600 V was applied. One second after initiation of the application, a current was measured, and the resistance value of the magnetic brush of the developer was calculated. In this calculation, the resistance value was based on a unit area of the electrodes of 1 cm².

Method for Measuring Coverage on Toner Particle Surface with External Additive

A toner was photographed with a scanning electron microscope (SEM) (model: S-4800, manufactured by Hitachi High-Technologies Corporation). Model calculation in a projected area was performed using the average particle diameter and specific gravity of toner particles (toner core) and the average particle diameter and specific gravity of each of external additives, and the coverage F with the respective external additive was determined using the following expression (1). In the expression, D is the average particle diameter (μm) of toner particles, ρt is the specific gravity of the toner particles, d is the average particle diameter (μm) of an external additive, pi is the specific gravity of the external additive, and C is (the mass of the external additive)/(the mass of the toner).

$$\begin{matrix}[ Expression 1 ] & \\ F = \frac{\sqrt{3}}{2 π} * \frac{{ρ}_{t} D}{{ρ}_{i} d} * C & ( 1 )\end{matrix}$$

### Method for Measuring Apparent Viscosity of Toner Particles

A flow tester (product name: CFT-100C, manufactured by Shimadzu Corporation) was set such that 1 g of toner was extruded from a die (nozzle diameter: 1.0 mm, length: 1.0 mm) by applying a load of 10 kgf/cm² (0.98 MPa), heating was performed at a temperature increasing rate of 6° C./min from 80° C. to 120° C., and a melt viscosity (apparent viscosity (Pa·s)) was determined.

### Evaluation Method

As an evaluation machine, a multifunctional color printer (product name: BP-20C25, manufactured by Sharp) was used. At an environmental test room, three environments where temperature and humidity were 25° C. and 5% RH, 25° C. and 50% RH, and 25° C. and 80% RH were prepared. In each of the environments, the evaluation machine was operated. A developer deteriorated by printing on 10,000 sheets of A4-size paper was used in each evaluation.

### Method for Evaluating Carrier Development

In evaluation of carrier development, a developer deteriorated by operating the evaluation machine in the environment of 25° C. and 5% RH was used. A solid image was printed on A4-size paper until the toner concentration in the developer (hereinafter also referred to as T/D) was reduced to 4% by mass. When T/D reached 4% by mass, a solid image was printed on 5 sheets of A4-size paper. Evaluation was performed on the basis of the total number of white sports caused by carrier development on the 5 sheets. Evaluation criteria are as follows.
Excellent: there is no white sport.
Good: there is one white sport.
Poor: there are two or more white sports.

### Method for Evaluating Development Memory

In evaluation of development memory, a developer deteriorated by operating the evaluation machine in the environment of 25° C. and 80% RH was used. A solid image was printed on A4-size paper until T/D was reduced to 4% by mass. An order of toner supply was given to the evaluation machine, to increase T/D to 12% by mass. Subsequently, an evaluation chart for evaluation of development memory was printed on 5 sheets of A4-size paper. In the evaluation chart, an image of the same size as the travel distance of one circumference of a magnet roller was printed, and a halftone was printed at a portion other than the image. When development memory occurs, an incidental image of the image of the same size as the travel distance of one circumference of a magnet roller is printed at a portion where a halftone was printed. The maximum number of apparent incidental image on one sheet of A4-size paper is five, and therefore the maximum number of apparent incidental image on five sheets of A4-size paper is 25. Evaluation was performed on the basis of the total number of incidental images caused by development memory in the evaluation chart of the 5 sheets. Evaluation criteria are as follows.
Excellent: there is no incidental image.
Good: there is one incidental image.
Fair: there are two or more and five or less incidental images.
Poor: there are six or more incidental images.

### Preparation Example of Toner Particles (Toner Core)

### Preparation of Toner Particles (I)

### (Material Mixing, Kneading, Milling, and Classifying Processes)

In preparation of toner particles (I), the following materials were used.

### Binder Resin

62% by mass of amorphous polyester resin
25% by mass of crystalline polyester resin

### Colorant

7% by mass of C.I.Pigmant Blue 15:3 (manufactured by DIC Corporation)

### Release Agent

5% by mass of ester wax (product name: WEP-5 manufactured by NOF Corporation)

### Charge Control Agent

1% by mass of salicylic acid-based compound (product name: Bontron E-84 manufactured by Orient Chemical Industries, Ltd.)

The aforementioned materials were pre-mixed for 5 minutes using an air mixer (Henschel mixer, model: FM20C manufactured by NIPPON COKE & ENGINEERING CO., LTD.), and then melted and kneaded using an open roll continuous kneader (model: MOS320-1800 manufactured by NIPPON COKE & ENGINEERING CO., LTD.), to obtain a melt-kneaded product (Mixing and kneading process). The setting conditions of the open rolling were a supply part temperature of 130° C. and an emission part temperature of 100° C. in a heating roller, and a supply part temperature of 40° C. and an emission part temperature of 25° C. in a cooling roller. As the heating roller and the cooling roller, rollers having a diameter of 320 mm and an effective length of 1,550 mm were employed, and both inter-roller gaps on the supply part and the emission part were set to 0.3 mm. The setting also had a rotation speed of the heating roller of 75 rpm, a rotation speed of the cooling roller of 65 rpm, and a supply of the toner material of 5.0 kg/h. The melt-kneaded material thus obtained was cooled on a cooling belt, and then roughly milled with a speed mill having a screen with φ 2 mm to produce a roughly-milled product (roughly milling process).

The roughly-milled product thus obtained was finely milled with a jet mill (model: IDS-2manufactured by Nippon Pneumatic Mfg. Co., Ltd.) to produce a finely-milled product (finely-milling process).

Then, the finely-milled product thus obtained was classified with an elbow jet classifier (model: EJ-LABO manufactured by Nittetsu Mining Co., Ltd.) to obtain toner particles (I) having an average primary particle diameter of 6.0 μm (classifying process).

### Preparation of Toner Particles (II)

Toner particles (II) were obtained in the same manner as the method for preparing the toner particles (I) except that the blending ratio of the binder resin was changed as follows.

### Binder Resin

47% by mass of amorphous polyester resin
40% by mass of crystalline polyester resin

### Preparation of Toner Particles (III)

Toner particles (III) were obtained in the same manner as the method for preparing the toner particles (I) except that the milling pressure in the finely-milling process was increased by 10%.

### Preparation of Toner Particles (IV)

Toner particles (IV) were obtained in the same manner as the method for preparing the toner particles (I) except that the milling pressure in the finely-milling process was reduced by 10%.

Preparation Example of Toner with External additive (Externally Adding Process)

Preparation of Toner with External Additive (a)

In an externally adding process for attaching an external additive to a toner particle surface, a first externally adding step and a second externally adding step were separately performed. In the first externally adding step, 100 parts by mass of the toner particles (I), 0.9 parts by mass of silica (product name: H2000T manufactured by WACKER), and 1.2 parts by mass of silica (product name: X-24-9163A manufactured by Shin-Etsu Chemical Co., Ltd.) were placed in a container, and mixed at a rotation speed of 3,500 rpm for 120 seconds using a FM mixer (model: FM-20 manufactured by NIPPON COKE & ENGINEERING CO., LTD.). In the second externally adding step, 0.8 parts by mass of fine powder (average primary particle diameter: 15 nm) as a charge control agent was then placed in the container, and mixed at a rotation speed of 3,500 rpm for 180 seconds. The resulting mixture was screened using a 270-mesh sieve, to obtain a toner with external additives (a). The fine powder added in the second externally adding step was one in which the surface of aluminum oxide having a crystal structure of a-alumina as a base body was treated with dimethyl polysiloxane.

Preparation of Toner with External Additive (b)

A toner with external additives (b) was obtained in the same manner as the method for preparing the toner with external additives (a) except that the used toner particles were changed into toner particles (II).

Preparation of Toner with External Additive (c)

A toner with external additives (c) was obtained in the same manner as the method for preparing the toner with external additives (a) except that the used toner particles were changed into toner particles (III).

Preparation of Toner with External Additive (d)

A toner with external additives (d) was obtained in the same manner as the method for preparing the toner with external additives (a) except that the used toner particles were changed into toner particles (IV).

Preparation of Toner with External Additive (e)

A toner with external additives (e) in which the coverage with the fine powder was 55% was obtained in the same manner as the method for preparing the toner with external additives (a) except that the amount of the fine powder placed in the second externally adding step was changed to 1.1 parts by mass.

Preparation of Toner with External Additive (f)

A toner with external additives (f) in which the coverage with the fine powder was 25% was obtained in the same manner as the method for preparing the toner with external additives (a) except that the amount of the fine powder placed in the second externally adding step was changed to 0.5 parts by mass.

Preparation of Toner with External Additive (g)

A toner with external additives (g) in which the coverage with the fine powder was 60% was obtained in the same manner as the method for preparing the toner with external additives (a) except that the amount of the fine powder placed in the second externally adding step was changed to 1.2 parts by mass.

Preparation of Toner with External Additive (h)

A toner with external additives (h) in which the coverage with the fine powder was 20% was obtained in the same manner as the method for preparing the toner with external additives (a) except that the amount of the fine powder placed in the second externally adding step was changed to 0.4 parts by mass.

Preparation of Toner with External Additive (i)

A toner with external additives (i) was obtained in the same manner as the method for preparing the toner with external additives (a) except that the average primary particle diameter of the fine powder placed in the second externally adding step was changed to 10 nm and the amount of the fine powder placed in the second externally adding step was changed to 0.53 parts by mass.

Preparation of Toner with External Additive (j)

A toner with external additives (j) was obtained in the same manner as the method for preparing the toner with external additives (a) except that the average primary particle diameter of the fine powder placed in the second externally adding step was changed to 25 nm and the amount of the fine powder placed in the second externally adding step was changed to 1.35 parts by mass.

Preparation of Toner with External Additive (k)

A toner with external additives (k) was obtained in the same manner as the method for preparing the toner with external additives (a) except that the average primary particle diameter of the fine powder placed in the second externally adding step was changed to 25 nm and the amount of the fine powder placed in the second externally adding step was changed to 0.66 parts by mass.

Preparation of Toner with External Additive (1)

A toner with external additives (1) was obtained in the same manner as the method for preparing the toner with external additives (a) except that the charge control agent placed in the second externally adding step was changed into 0.8 parts by mass of strontium titanate (product name: SW-100 manufactured by Titan kogyo, Ltd.).

Preparation of Toner with External Additive (m) A toner with external additives (m) was obtained in the same manner as the method for preparing the toner with external additives (a) except that the average primary particle diameter of the fine powder placed in the second externally adding step was changed to 8 nm and the amount of the fine powder placed in the second externally adding step was changed to 0.43 parts by mass.

Preparation of Toner with External Additive (n)

A toner with external additives (n) was obtained in the same manner as the method for preparing the toner with external additives (a) except that the average primary particle diameter of the fine powder placed in the second externally adding step was changed to 30 nm and the amount of the fine powder placed in the second externally adding step was changed to 1.6 parts by mass.

### Preparation Example of Carrier

Preparation of Carrier A 0.375 parts by mass of silicone resin 1 (product name: KR240 manufactured by Shin-Etsu Chemical Co., Ltd.) and 0.375 parts by mass of silicone resin 2 (product name: KR251 manufactured by Shin-Etsu Chemical Co., Ltd.) were dissolved in 12 parts by mass of toluene, and in the solution, 0.0375 parts by mass of conductive fine particles (product name: VULCAN XC-72 manufactured by Cabot Corporation) and 0.0225 parts by mass of coupling agent (product name: AY43-059 manufactured by Dow corning toray CO., Ltd.) were dispersed, to prepare a coating resin liquid A.

The coating resin liquid A was used in an amount of 12.8 parts by mass relative to 100 parts by mass of carrier core material. The surface of the carrier core material was coated with the coating resin liquid A by an immersion method. After curing at a curing temperature of 200° C. for a curing time of 1 hour, screening through a sieve with an opening of 150 μm was performed to produce a carrier A.

### Preparation of Carrier B

0.375 parts by mass of silicone resin 1 (product name: KR240 manufactured by Shin-Etsu Chemical Co., Ltd.) and 0.375 parts by mass of silicone resin 2 (product name: KR251 manufactured by Shin-Etsu Chemical Co., Ltd.) were dissolved in 12 parts by mass of toluene, and in the solution, 0.0225 parts by mass of coupling agent (product name: AY43-059 manufactured by Dow corning toray CO., Ltd.) was dispersed, to prepare a coating resin liquid B.

0.375 parts by mass of silicone resin 1 (product name: KR240 manufactured by Shin-Etsu Chemical Co., Ltd.) and 0.375 parts by mass of silicone resin 2 (product name: KR251 manufactured by Shin-Etsu Chemical Co., Ltd.) were dissolved in 12 parts by mass of toluene, and in the solution, 0.0375 parts by mass of conductive fine particles (product name: VULCAN XC-72 manufactured by Cabot Corporation) and 0.0225 parts by mass of coupling agent (product name: AY43-059 manufactured by Dow corning toray CO., Ltd.) were dispersed, to prepare a coating resin liquid C.

The coating resin liquid B was used in an amount of 6.4 parts by mass relative to 100 parts by mass of carrier core material. The coating resin liquid C was used in an amount of 6.4 parts by mass relative to 100 parts by mass of carrier core material. The surface of the carrier core material was first coated with the coating resin liquid B by an immersion method. Curing was performed at a curing temperature of 200° C. for a curing time of 1 hour. After that, the carrier core material was further coated with the coating resin liquid C. Curing was performed at a curing temperature of 200° C. for a curing time of 1 hour, and screening through a sieve with an opening of 150 μm was performed to produce a carrier B.

### Preparation of Carrier C

0.375 parts by mass of silicone resin 1 (product name: KR240 manufactured by Shin-Etsu Chemical Co., Ltd.) and 0.375 parts by mass of silicone resin 2 (product name: KR251 manufactured by Shin-Etsu Chemical Co., Ltd.) were dissolved in 12 parts by mass of toluene, and in the solution, 0.0225 parts by mass of coupling agent (product name: AY43-059 manufactured by Dow corning toray CO., Ltd.) was dispersed, to prepare a coating resin liquid B.

0.375 parts by mass of silicone resin 1 (product name: KR240 manufactured by Shin-Etsu Chemical Co., Ltd.) and 0.375 parts by mass of silicone resin 2 (product name: KR251 manufactured by Shin-Etsu Chemical Co., Ltd.) were dissolved in 12 parts by mass of toluene, and in the solution, 0.0714 parts by mass of conductive fine particles (product name: VULCAN XC-72 manufactured by Cabot Corporation), and 0.0225 parts by mass of coupling agent (product name: AY43-059 manufactured by Dow corning toray CO., Ltd.) were dispersed, to prepare a coating resin liquid D.

The coating resin liquid B was used in an amount of 6.4 parts by mass relative to 100 parts by mass of carrier core material. The coating resin liquid D was used in an amount of 6.4 parts by mass relative to 100 parts by mass of carrier core material. The surface of the carrier core material was first coated with the coating resin liquid B by an immersion method. Curing was performed at a curing temperature of 200° C. for a curing time of 1 hour. After that, the carrier core material was further coated with the coating resin liquid D. Curing was performed at a curing temperature of 200° C. for a curing time of 1 hour, and screening through a sieve with an opening of 150 μm was performed to produce a carrier C.

### Preparation Example of Two-Component Developer

The toners with external additives (a) to (n) and the carriers A to C were combined as shown in Table 1 below, to produce developers 1 to 17 that were two-component developers. In the production of the two-component developers, the components were mixed for 20 minutes with a V type mixer (product name: V-5 manufactured by TOKUJU CORPORATION) such that the toner concentration was 7% by mass.

TABLE 1

| | | | | | | | Change | | |
|---|---|---|---|---|---|---|---|---|---|
| | | | | | | | ratio of | | |
| | | | | Resistance | Resistance | Resistance | resistance | | |
| | | | | (GΩ · cm²) | (GΩ · cm²) | (GΩ · cm²) | under | Volume | |
| | Developer | | | under | under | under | application | resistivity | |
| | | Components | | application | application | application | of 600 V to | (Ω · cm) | |
| | | Toner | | of 1,000 V | of 600 V | of 600 V | developer | of toner | |
| | | with | | to T/D | to T/D | to T/D | (per toner | with | Type of |
| | | external | | 4% | 4% | 12% | concentration | external | charge |
| | No. | additive | Carrier | developer | developer | developer | of +1%) | additive | modifier |
| Example | 4 | (a) | B | 1.46 | 19.57 | 23.67 | 0.5 | 3.52E+14 | Fine |
| 1 | | | | | | | | | powder |
| Example | 5 | (b) | B | 1.46 | 19.57 | 23.67 | 0.5 | 3.50E+14 | Fine |
| 2 | | | | | | | | | powder |
| Example | 6 | (c) | B | 1.46 | 19.52 | 23.74 | 0.5 | 3.55E+14 | Fine |
| 3 | | | | | | | | | powder |
| Example | 7 | (d) | B | 1.46 | 19.50 | 23.62 | 0.5 | 3.44E+14 | Fine |
| 4 | | | | | | | | | powder |
| Example | 8 | (e) | B | 1.46 | 19.50 | 23.62 | 0.5 | 3.40E+14 | Fine |
| 5 | | | | | | | | | powder |
| Example | 9 | (f) | B | 1.46 | 19.52 | 23.79 | 0.5 | 3.61E+14 | Fine |
| 6 | | | | | | | | | powder |
| Example | 10 | (g) | B | 1.45 | 19.37 | 23.30 | 0.5 | 1.95E+14 | Fine |
| 7 | | | | | | | | | powder |
| Example | 11 | (h) | B | 1.48 | 19.74 | 24.16 | 0.6 | 4.26E+14 | Fine |
| 8 | | | | | | | | | powder |
| Example | 12 | (i) | B | 1.45 | 19.13 | 23.06 | 0.5 | 2.80E+14 | Fine |
| 9 | | | | | | | | | powder |
| Example | 13 | (i) | B | 1.46 | 79.74 | 24.16 | 0.6 | 3.58E+14 | Fine |
| 10 | | | | | | | | | powder |
| Example | 17 | (k) | B | 1.48 | 19.80 | 28.50 | 1.1 | 4.36E+14 | Fine |
| 11 | | | | | | | | | powder |
| Compar- | 1 | (l) | A | 1.86 | 13.20 | 218.72 | 25.7 | 8.56E+14 | Strontium |
| ative | | | | | | | | | titanate |
| Example | | | | | | | | | |
| 1 | | | | | | | | | |
| Compar- | 2 | (l) | B | 8.78 | 65.55 | 347.13 | 35.2 | 8.56E+14 | Strontium |
| ative | | | | | | | | | titanate |
| Example | | | | | | | | | |
| 2 | | | | | | | | | |
| Compar- | 3 | (a) | A | 0.24 | 2.53 | 32.45 | 3.7 | 3.52E+14 | Fine |
| ative | | | | | | | | | powder |
| Example | | | | | | | | | |
| 3 | | | | | | | | | |
| Compar- | 14 | (m) | B | 1.44 | 18.83 | 22.81 | 0.5 | 1.98E+14 | Fine |
| ative | | | | | | | | | powder |
| Example | | | | | | | | | |
| 4 | | | | | | | | | |
| Compar- | 15 | (n) | B | 1.49 | 19.96 | 25.07 | 0.6 | 3.80E+14 | Fine |
| ative | | | | | | | | | powder |
| Example | | | | | | | | | |
| 5 | | | | | | | | | |
| Compar- | 16 | (a) | C | 1.14 | 14.71 | 19.62 | 0.6 | 3.52E+14 | Fine |
| ative | | | | | | | | | powder |
| Example | | | | | | | | | |
| 6 | | | | | | | | | |

| | | | | | | Ratio | | |
|---|---|---|---|---|---|---|---|---|
| | | Addition | | | | (%) of fine | | |
| | Apparent | amount | | | Apparent | powder in | | |
| | density | of | Particle | | viscosity | particle | | |
| | (g/cm³) | charge | diameter | Coverage | (Pa · s) | size | | |
| | of T/D | modifier | (nm) | (%) | at 90° C. | distribution | | |
| | 4% | (part | of fine | with fine | of toner | of toner | Development | Carrier |
| | developer | by mass) | powder | powder | particles | particles | memory | development |
| Example | 1.74 | 0.8 | 15 | 40 | 177600 | 20 | Good | Excellent |
| 1 | | | | | | | | |
| Example | 1.75 | 0.8 | 15 | 40 | 81500 | 20 | Fair | Excellent |
| 2 | | | | | | | | |
| Example | 1.71 | 0.8 | 15 | 40 | 177600 | 30 | Fair | Excellent |
| 3 | | | | | | | | |
| Example | 1.75 | 0.8 | 15 | 40 | 177600 | 15 | Excellent | Excellent |
| 4 | | | | | | | | |
| Example | 1.76 | 1.1 | 15 | 55 | 177600 | 20 | Good | Excellent |
| 5 | | | | | | | | |
| Example | 1.73 | 0.5 | 15 | 25 | 177600 | 20 | Good | Excellent |
| 6 | | | | | | | | |
| Example | 1.78 | 1.2 | 15 | 60 | 177600 | 20 | Good | Good |
| 7 | | | | | | | | |
| Example | 1.71 | 0.4 | 15 | 20 | 177600 | 20 | Fair | Excellent |
| 8 | | | | | | | | |
| Example | 1.75 | 0.53 | 10 | 40 | 177600 | 20 | Good | Excellent |
| 9 | | | | | | | | |
| Example | 1.73 | 1.35 | 25 | 40 | 177600 | 20 | Good | Excellent |
| 10 | | | | | | | | |
| Example | 1.70 | 0.66 | 25 | 20 | 177600 | 20 | Fair | Excellent |
| 11 | | | | | | | | |
| Compar- | 1.69 | 0.8 | — | — | 177600 | 20 | Poor | Excellent |
| ative | | | | | | | | |
| Example | | | | | | | | |
| 1 | | | | | | | | |
| Compar- | 1.68 | 0.8 | — | — | 177600 | 20 | Poor | Excellent |
| ative | | | | | | | | |
| Example | | | | | | | | |
| 2 | | | | | | | | |
| Compar- | 1.76 | 0.8 | 15 | 40 | 177600 | 20 | Fair | Poor |
| ative | | | | | | | | |
| Example | | | | | | | | |
| 3 | | | | | | | | |
| Compar- | 1.77 | 0.43 | 8 | 40 | 177600 | 20 | Fair | Poor |
| ative | | | | | | | | |
| Example | | | | | | | | |
| 4 | | | | | | | | |
| Compar- | 1.71 | 1.6 | 30 | 40 | 177600 | 20 | Poor | Good |
| ative | | | | | | | | |
| Example | | | | | | | | |
| 5 | | | | | | | | |
| Compar- | 2.05 | 0.8 | 15 | 40 | 177600 | 20 | Fair | Poor |
| ative | | | | | | | | |
| Example | | | | | | | | |
| 6 | | | | | | | | |

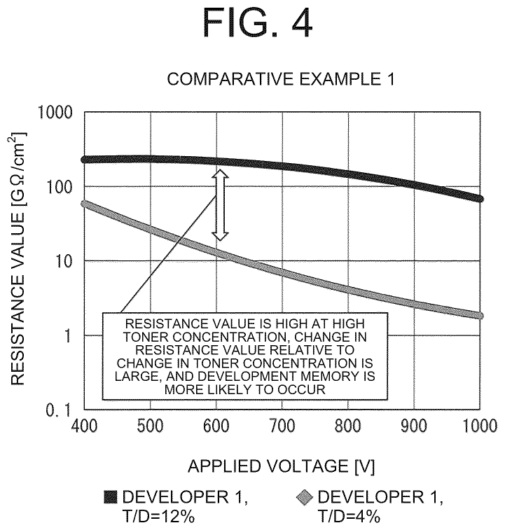

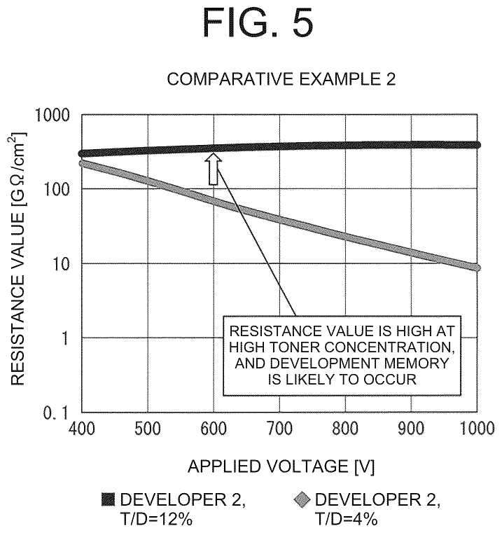

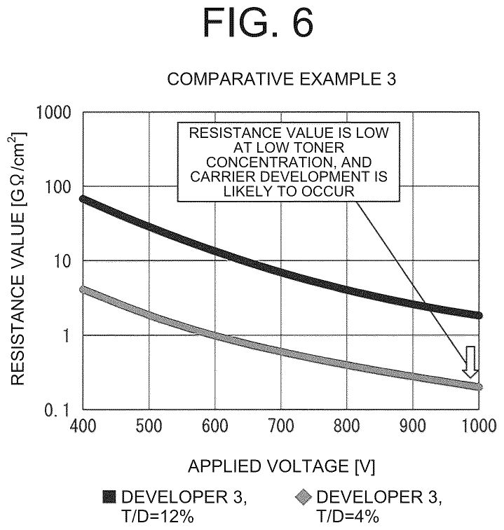

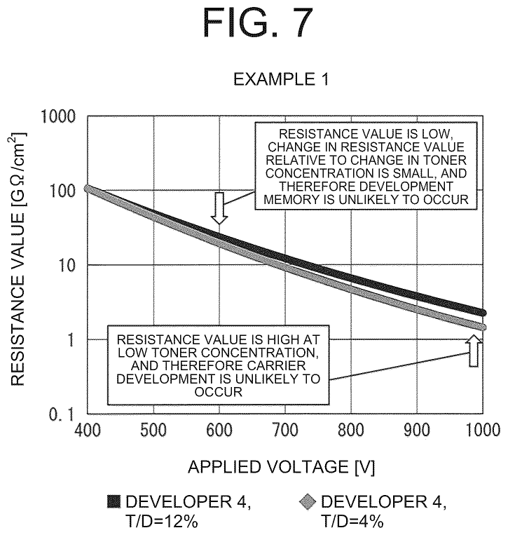

Table 1 shows the types of the materials, and physical properties and evaluation results of the developers in Examples and Comparative Examples. In Table 1, the “fine powder” in “ratio of fine powder in particle size distribution of toner particles” represents toner particles having a particle diameter of 0.6×D or less, wherein D is the average primary particle diameter of the toner particles. FIGS. 4 to 7 are graphs showing the measurement results of the resistance values of the magnetic brushes of the developers in Comparative Examples 1 to 3 and Example 1.

According to Table 1 and FIGS. 4 to 7, the two-component developers in Examples 1 to 11 that were a two-component developer containing a toner and a carrier, wherein the toner is a toner in which an external additive is attached to a toner particle surface, the external additive contains a fine powder having an average primary particle diameter of 10 nm or more and 25 nm or less, the fine powder contains aluminum, the apparent density of the two-component developer is 1.7 g/cm³ or more and 2.0 g/cm³ or less at a toner concentration in the two-component developer of 4% by mass, the resistance value when a voltage of 1,000 V is applied to a magnetic brush having a length of 0.1 cm formed by filling a space between two electrodes disposed apart from each other by 0.1 cm and parallel to each other in a magnetic field of 200 mT with the two-component developer at a filling rate of 20% is 1 GΩ or more per square centimeter of the electrodes, and the resistance value when a voltage of 600 V is applied to the magnetic brush is 22 GQ or less per square centimeter of the electrodes suppressed the occurrence of carrier development and development memory.

By contrast, Comparative Examples 1 to 6, which do not satisfy these requirements, were inferior to the Examples in at least one evaluation item of the evaluation results of carrier development and development memory.

Example 1 in which the apparent viscosity at 90° C. of the toner particles is 100,000 Pa·s or more and 200,000 Pa·s or less can suppress the occurrence of development memory as compared with Example 2 in which the apparent viscosity is less than 100,000 Pa·s.

Examples 3 and 4 are examples in which the ratio of the fine powder in the particle size distribution of the toner particles is changed. Herein, the fine powder refers to toner particles having a particle diameter of 0.6×D or less, wherein D is the average primary particle diameter of the toner particles. Example 1 in which the ratio of the fine powder is 20% or less can suppress the occurrence of development memory as compared with Example 3 in which the ratio is more than 20%. Example 4 in which the ratio of the fine powder is 15% can further suppress the occurrence of development memory as compared with Example 1.

Examples 5 to 8 are examples in which the coverage on the toner particle surface with the fine powder in the external additives is changed. Examples 5 and 6 in which the coverage is 25% or more and 55% or less can suppress the occurrence of carrier development as compared with Example 7 in which the coverage is more than 55%. Furthermore, Examples 5 and 6 can suppress the occurrence of development memory as compared with Example 8 in which the coverage is less than 25%.

Examples 9 and 10 and Comparative Examples 4 and 5 are examples in which the average primary particle diameter of the fine powder in the external additives is changed. Examples 9 and 10 in which the average primary particle diameter is 10 nm or more and 25 nm or less can suppress the occurrence of carrier development as compared with Comparative Example 4 in which the average primary particle diameter is less than 10 nm. Furthermore, Examples 9 and 10 can suppress the occurrence of development memory as compared with Comparative Example 5 in which the average primary particle diameter is more than 25 nm.

In Examples 5, 6, 9, and 10 in which the occurrence of development memory and carrier development can be more suppressed, among Examples 5 to 10, the volume resistivity of the toner under compression to a density of 0.9 g/cm³ or more and 1.1 g/cm³ or less is 2.0×10¹⁴ Ω·cm or more and 3.7×10¹⁴ Ω·cm or less. In other words, it is seen that when the volume resistivity of the toner is within the aforementioned range, the occurrence of development memory and carrier development can be more suppressed.

Example 1 in which the change amount of the resistance value when a voltage of 600 Vis applied to the magnetic brush during a change of the toner concentration in the two-component developer by 1% by mass is 1.0 G(2 or less per square centimeter of the electrodes can suppress the occurrence of development memory as compared with Example 11 in which the change amount of the resistance value is more than the upper limit. The change amount of the resistance value in Table 1 is a value when the toner concentration is changed from 4% by mass to 12% by mass.

Examples 1 to 10 in which the resistance value when a voltage of 600 V is applied to the magnetic brush having a length of 0.1 cm formed by filling the space between the two electrodes disposed apart from each other by 0.1 cm and parallel to each other in a magnetic field of 200 mT with the two-component developer having a toner concentration of 12% by mass at a filling rate of 20% is 30 GΩ or less per square centimeter of the electrodes can suppress the occurrence of development memory as compared with Comparative Examples 1 to 3 in which the resistance value is more than 30 GΩ. Comparison between Example 1 in which the resistance value is 24 GQ or less and Comparative Example 5 in which the resistance value is more than 24 GΩ shows that Example 1 can more suppress the occurrence of development memory.

The embodiments disclosed herein are illustrative in every respect, and do not serve as a basis for limitative interpretation. Accordingly, the technical scope of the present disclosure is not construed only by the embodiments described above, but defined on the basis of the recitation of the claims. The appended claims and their equivalents are intended to cover all changes and modifications as would fall within the scope and spirit of the disclosure.

1. A two-component developer comprising a toner and a carrier, wherein
the toner is a toner in which an external additive is attached to a toner particle surface,
the external additive contains a fine powder having an average primary particle diameter of 10 nm or more and 25 nm or less,
the fine powder contains aluminum,
an apparent density of the two-component developer is 1.7 g/cm³ or more and 2.0 g/cm³ or less at a toner concentration in the two-component developer of 4% by mass,
a resistance value when a voltage of 1,000 V is applied to a magnetic brush having a length of 0.1 cm formed by filling a space between two electrodes disposed apart from each other by 0.1 cm and parallel to each other in a magnetic field of 200 mT with the two-component developer having a toner concentration of 4% by mass at a filling rate of 20% is 1 GΩ or more per square centimeter of the electrodes, and
a resistance value when a voltage of 600 V is applied to the magnetic brush is 22 GΩ or less per square centimeter of the electrodes.

2. The two-component developer according to claim 1, wherein
a change amount of the resistance value when a voltage of 600 V is applied to the magnetic brush, per change of 1% by mass when the toner concentration in the two-component developer is changed from 4% by mass to 12% by mass, is 1.0 GΩ or less per square centimeter of the electrodes.

3. The two-component developer according to claim 1, wherein
the toner has a volume resistivity of 2.0×10¹⁴ Ω·cm or more and 3.7×10¹⁴ Ω·cm or less under compression to a density of 0.9 g/cm³ or more and 1.1 g/cm³ or less.

4. The two-component developer according to claim 1, wherein
a coverage on the toner particle surface with the fine powder is 25% or more and 55% or less.

5. The two-component developer according to claim 1, wherein
the toner particles have an average primary particle diameter of 4 μm or more and 7 μm or less and an apparent viscosity at 90° C. of 100,000 Pa·s or more and 200,000 Pa·s or less.

6. The two-component developer according to claim 1, wherein
a ratio of the toner particles having a particle diameter of 0.6×D or less, wherein D is the average primary particle diameter of the toner particles, is 20% or less of a whole particle size distribution of the toner particles.

7. The two-component developer according to claim 1, wherein
a resistance value when a voltage of 600 V is applied to a magnetic brush having a length of 0.1 cm formed by filling a space between two electrodes disposed apart from each other by 0.1 cm and parallel to each other in a magnetic field of 200 mT with the two-component developer having a toner concentration of 12% by mass at a filling rate of 20% is 30 GΩ or less per square centimeter of the electrodes.

8. An image-forming apparatus using the two-component developer according to claim 1.
